(19) United States
(12) Patent Application Publication
(10) Pub. No.: US 2025/0384479 A1
(43) Pub. Date: Dec. 18, 2025

(54) SYSTEM, SERVER APPARATUS, CONTROL METHOD OF SERVER APPARATUS, AND NON-TRANSITORY COMPUTER-READABLE STORAGE MEDIUM

(71) Applicant: NEC Corporation, Tokyo (JP)

(72) Inventors: Eiji KANEKO, Tokyo (JP); Yoshitomo Warashina, Tokyo (JP); Shingo Hirota, Tokyo (JP); Toshio Koide, Tokyo (JP)

(73) Assignee: NEC Corporation, Tokyo (JP)

(21) Appl. No.: 19/229,095

(22) Filed: Jun. 5, 2025

(30) Foreign Application Priority Data
Jun. 14, 2024 (JP) 2024-096357

(51) Int. Cl. G06Q 30/0601

(52) U.S. Cl. CPC G06Q 30/0635; G06Q 30/0641

(57) ABSTRACT

A system includes a certificate issuance means and an NFT issuance means. The certificate issuance means issues a purchase certificate related to a product or service purchased by a user. The NFT issuance means issues, in a case where a verification of the issued purchase certificate succeeds, to the user, an NFT (Non-Fungible Token) of digital content related to the product or service purchased by the user.

### INCORPORATION BY REFERENCE

This application is based upon and claims the benefit of priority from Japanese Patent Application No. 2024-096357, filed on Jun. 14, 2024, the disclosure of which is incorporated herein in its entirety by reference.

### TECHNICAL FIELD

The present invention relates to a system, a server apparatus, a control method of a server apparatus, and a non-transitory computer-readable storage medium.

### BACKGROUND ART

There is a technology related to the distribution of an NFT (Non-Fungible Token) and digital content.

For example, Patent Literature 1 (JP2024-057690 A) describes that digital content and an NFT can be managed so as to be independently distributable.

A processing apparatus of Patent Literature 1, in a case where a user acquires digital content, generates content owner information by associating the user with the content, and stores the content owner information in a memory.

Further, the processing apparatus, in a case where a request for issuance of an NFT for the content is accepted, performs a request for issuance processing of the NFT to a distributed ledger system. Further, the processing apparatus, in a case where the completion of issuance of the NFT for the content is accepted, generates NFT owner information by associating the user with the NFT based on the content owner information, and stores the NFT owner information in the memory. Further, the processing apparatus, in a case where a request for transfer of ownership of only the NFT is accepted, maintains the content owner information and updates the NFT owner information.

There is a user who desires to acquire digital content corresponding to a purchased product or service. Further, there is a need to transfer the acquired digital content. However, there is no system that enables the sale and purchase of the digital content while guaranteeing that the user has purchased a product or the like corresponding to the digital content.

It should be noted that Patent Literature 1 merely discloses a technology that enables digital content and an NFT to be independently distributable. Therefore, even if the technology disclosed in Patent Literature 1 is applied, it is not possible to realize the above-described system.

### SUMMARY

It is a main object of the present invention to provide a system, a server apparatus, a control method of a server apparatus, and a non-transitory computer-readable storage medium that contribute to realizing the distribution of digital content corresponding to a product or service purchased by a user.

According to a first aspect of the present invention, there is provided a system, including: a certificate issuance means that issues a purchase certificate related to a product or service purchased by a user; and an NFT (Non-Fungible Token) issuance means that issues, in a case where a verification of the issued purchase certificate succeeds, to the user, an NFT of digital content corresponding to the product or service purchased by the user.

According to a second aspect of the present invention, there is provided a server apparatus, including: a receiving means that receives, from a store server operated by an electronic book store where a user has purchased an electronic book, an electronic book purchase notification including a wallet address of the user; and an issuance means that issues, to the user, a purchase certificate that proves that the user has purchased the electronic book by using the wallet address of the user.

According to a third aspect of the present invention, there is provided a control method of a server apparatus, the control method including: receiving, from a store server operated by an electronic book store where a user has purchased an electronic book, an electronic book purchase notification including a wallet address of the user; and issuing, to the user, a purchase certificate that proves that the user has purchased the electronic book by using the wallet address of the user.

According to a fourth aspect of the present invention, there is provided a non-transitory computer-readable storage medium storing a program causing a computer mounted on a server apparatus to perform processing for: receiving, from a store server operated by an electronic book store where a user has purchased an electronic book, an electronic book purchase notification including a wallet address of the user; and issuing, to the user, a purchase certificate that proves that the user has purchased the electronic book by using the wallet address of the user.

### BRIEF DESCRIPTION OF THE DRAWINGS

Exemplary features and advantages of the present invention will become apparent from the following detailed description when taken with the accompanying drawings in which:

FIG. 1 is a diagram illustrating an outline of an example embodiment;

FIG. 2 is a flowchart illustrating an operation of an example embodiment;

FIG. 3 is a diagram illustrating an example of a schematic configuration of an information processing system according to an example embodiment of the present disclosure;

FIG. 4 is a diagram illustrating an operation of the information processing system according to the example embodiment of the present disclosure;

FIG. 5 is a diagram illustrating the operation of the information processing system according to an example embodiment of the present disclosure;

FIG. 6 is a diagram illustrating an example of a processing configuration of a management server according to the example embodiment of the present disclosure;

FIG. 7 is a diagram illustrating an example of a user management database according to the example embodiment of the present disclosure;

FIG. 8 is a diagram illustrating an example of a display of a terminal according to the example embodiment of the present disclosure;

FIG. 9 is a diagram illustrating an example of the display of the terminal according to the example embodiment of the present disclosure;

FIG. 10 is a diagram illustrating an example of a processing configuration of an electronic agency server according to the example embodiment of the present disclosure;

FIG. 11 is a flowchart illustrating an example of an operation of a sales control unit according to the example embodiment of the present disclosure;

FIG. 12 is a diagram illustrating an example of the display of the terminal according to the example embodiment of the present disclosure;

FIG. 13 is a sequence diagram illustrating an example of the operation of the information processing system according to the example embodiment of the present disclosure;

FIG. 14 is a diagram illustrating an example of a hardware configuration of a management server according to the present disclosure; and

FIG. 15 is a diagram illustrating an example of the display of the terminal according to a variation of the present disclosure.

### EXAMPLE EMBODIMENT

First, an outline of an example embodiment will be described. In the following outline, various components are denoted by reference characters for the sake of convenience. That is, the following reference characters are used as examples to facilitate the understanding of the present invention. Thus, the description of the outline is not intended to impose any limitations. In addition, unless otherwise specified, an individual block illustrated in the drawings represents a configuration of a functional unit, not a hardware unit. An individual connection line between blocks in the drawings signifies both one-way and two-way directions. An arrow schematically illustrates a principal signal (data) flow and does not exclude bidirectionality. In the present description and drawings, elements that can be described in a like way will be denoted by a like reference character, and redundant description thereof will be omitted as needed.

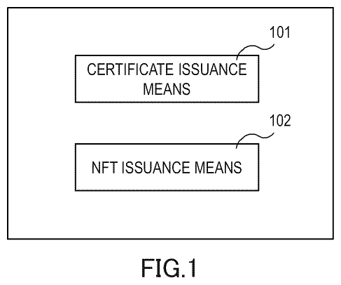

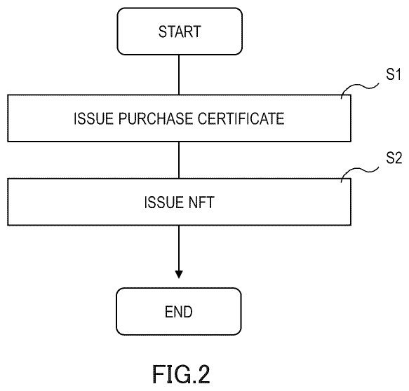

A system according to an example embodiment includes a certificate issuance means 101 and an NFT issuance means 102 (see FIG. 1). The certificate issuance means 101 issues a purchase certificate related to a product or service purchased by a user (step S1 of FIG. 2). The NFT issuance means 102 issues, in a case where a verification of the issued purchase certificate succeeds, to the user, an NFT (Non-Fungible Token) of digital content related to the product or service purchased by the user (step S2).

The above system issues a purchase certificate related to a product or the like in accordance with a purchase of a product or service by the user. In a case where verification of the purchase certificate issued to the user succeeds, the system issues an NFT corresponding to digital content related to a product or the like purchased by the user.

Since the NFT indicates ownership of the digital content by the user, the digital content can be a subject of sale and purchase. That is, the system according to the above example embodiment can realize distribution of digital content corresponding to a product or service purchased by the user.

Hereinafter, specific example embodiments will be described in more detail with reference to drawings.

### First Example Embodiment

A first example embodiment will be described in more detail with reference to drawings.

An information processing system according to a first example embodiment issues an NFT (Non-Fungible Token) of digital content corresponding to a product or service purchased by a user. In the first example embodiment, an electronic book is taken as an example of a product to be purchased by the user for explanation.

### System Configuration

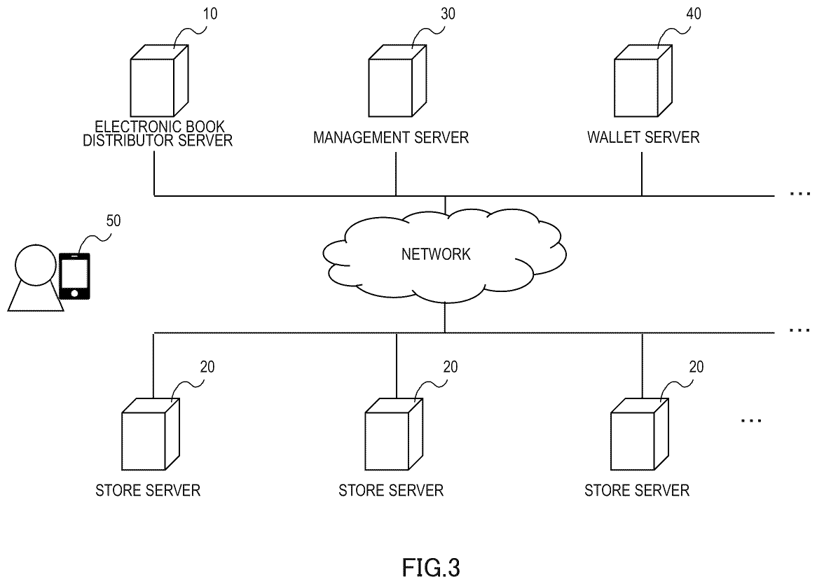

As shown in FIG. 3, the information processing system according to the first example embodiment includes an electronic book distributor server 10, at least one or more store servers 20, a management server 30, and a wallet server 40.

A user possesses a terminal 50 such as a smartphone. The user operates the terminal 50 to access the management server 30 or the like.

The electronic book distributor server 10 is a server that is

managed and operated by an electronic book distributor. The electronic book distributor server 10 handles an electronic book received from a publisher and performs distribution and sale of the electronic book.

More specifically, the electronic book distributor server 10 provides an electronic book, which is to be sold by an electronic book store to a consumer, to the electronic book store. Further, the electronic book distributor server 10 realizes a so-called marketplace. The electronic book distributor server 10 sells an NFT of an electronic book through the marketplace.

The store server 20 is a server that is managed and operated by the electronic book store that sells an electronic book. The user generates an account in the electronic book store and purchases an electronic book from the generated account.

An electronic book purchased by the user is downloaded to the terminal 50. The user is able to browse the purchased electronic book using a dedicated application (an application installed in a smartphone or the like). Alternatively, the user may browse the purchased electronic book by logging in to an account of the electronic book store.

The management server 30 is a server that is managed and operated by a business operator (a platform business operator) that provides a management platform for an electronic book across a plurality of electronic book stores. The management server 30 provides a cross-sectional management service (a management service related to an electronic book) related to at least one or more electronic book stores in which the user has an account.

Specifically, the user is able to log in to the account generated in the electronic book store via the management server 30. Further, in a case where the user purchases an electronic book at the electronic book store, the fact is notified to the management server 30.

The management server 30 generates a list (a book list) of electronic books purchased by the user from each electronic book store based on the notification. The user is able to select an electronic book to browse from among the book list held by the management server 30.

For example, the management server 30 changes a connection destination of the terminal 50 to the store server 20 of the electronic book store that has sold an electronic book selected by the user (redirects the connection destination of the terminal 50 to a login page of the electronic book store). Alternatively, the management server 30 launches an application corresponding to a format of the electronic book selected by the user (the downloaded electronic book).

It should be noted that a user is able to purchase an electronic book having the same title from the same electronic book store or a different electronic book store. That is, the user is able to make a duplicate purchase of an electronic book.

The wallet server 40 is a server that provides a wallet service related to tokens such as an NFT and an SBT (SoulBound Token). A user is able to prove ownership of an NFT or an SBT by opening an account (a wallet) in the wallet server 40.

Each apparatus shown in FIG. 3 is connected to a network. Specifically, the electronic book distributor server 10, the store server 20, the management server 30, the wallet server 40, and the terminal 50 are connected to the network via wired or wireless communication means.

The configuration of the information processing system shown in FIG. 3 is an example and is not intended to limit the configuration of the information processing system. For example, a plurality of management servers 30 may be included in the system. Load balancing and redundancy may be achieved by the plurality of management servers 30.

### Outline of Operation

Next, a schematic operation of the information processing system according to the first example embodiment will be described.

### Generation of Account

A user generates an account for each service provider in order to purchase an electronic book, use a management service related to an electronic book, use a marketplace, and enjoy a wallet service.

Specifically, the user operates the terminal 50 to access the wallet server 40 and generates an account (a wallet). The user operates the terminal 50 to generate an account in an electronic book store that handles an electronic book the user desires to purchase. The user operates the terminal 50 to generate an account in the management server 30. The user operates the terminal 50 to generate an account (a marketplace account) in the electronic book distributor server 10.

Here, the user sets a common ID as identification information in an account of each service provider. Specifically, the user sets a wallet address (a wallet address generated by the wallet server 40) as the common ID in the electronic book distributor server 10, the store server 20, and the management server 30.

Each service provider stores the common ID in association with login information (ID, password) of the user and the like.

### Purchase of Electronic Book

In order to purchase an electronic book, the user logs in to an account of the management server 30. The management server 30 displays a list of electronic book stores on the terminal 50 and enables the user to select an electronic book store.

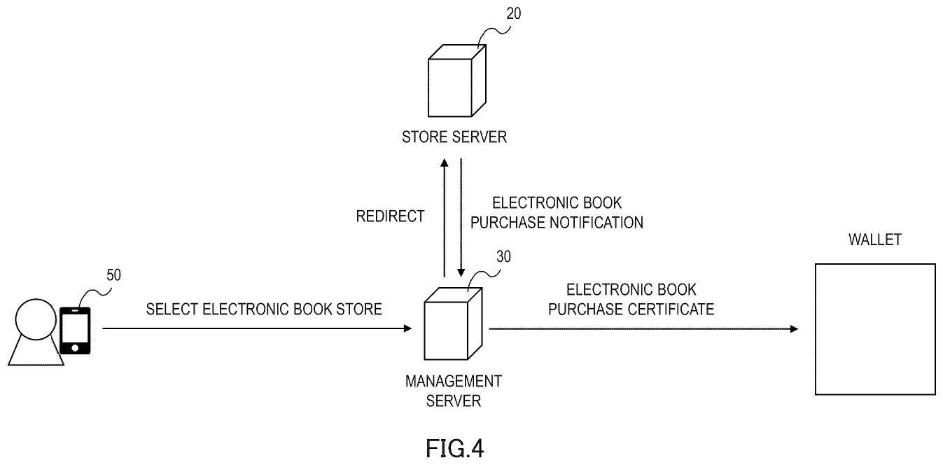

The management server 30 redirects a connection destination of the terminal 50 to a login page of the electronic book store selected by the user (see FIG. 4). Specifically, the management server 30 transmits a URL (Uniform Resource Locator) for logging in to an account of the electronic book store selected by the user to the terminal 50.

The URL transmitted to the terminal 50 is a URL for redirection for connecting the terminal 50 to a login page of the electronic book store, and the common ID of the user is embedded in the URL for redirection.

The terminal 50, in a case where a URL for redirection is received, accesses a login page of the electronic book store in accordance with the URL. At that time, since the URL for redirection includes a common ID, the store server 20 is able to acquire the common ID of the user.

The user purchases an electronic book in the logged-in electronic book store. In a case where the user purchases the electronic book, the store server 20 notifies the management server 30 of the fact that the user has purchased the electronic book. Specifically, the store server 20 transmits an “electronic book purchase notification” including the common ID of the purchaser of the electronic book and information related to the purchased electronic book (for example, a title of the book, a publisher name, a list price, an ISBN (International Standard Book Number) code, or the like) to the management server 30.

Here, a payment made by the purchaser of the electronic book is distributed at a predetermined ratio to four parties: a publisher, an electronic book distributor, an electronic book store, and an application store (a store that sells an application for browsing an electronic book). For example, A1% of a sales price (list price) of the electronic book is distributed to the publisher, A2% to the electronic book distributor, A3% to the electronic book store, and A4% to the application store, respectively.

The management server 30 identifies the user who has purchased an electronic book by using the common ID included in the electronic book purchase notification. The management server 30 stores information related to the electronic book purchased by the identified user in the account of the user. For example, the management server 30 stores a name of the electronic book store where the electronic book has been purchased and information related to the purchased electronic book (for example, a title of the book, a publisher name, a list price, and an ISBN code).

### Purchase NFT for Electronic Book

A user who has purchased an electronic book is able to purchase an NFT-converted electronic book corresponding to the purchased electronic book. More specifically, the user is able to purchase an NFT-converted electronic book having the same content as the purchased electronic book (hereinafter referred to as an NFT electronic book). In other words, the user who has purchased an electronic book at the electronic book store is able to acquire a right to purchase an NFT electronic book corresponding to the purchased electronic book.

It should be noted that, in the first example embodiment, a case where a user is able to purchase one NFT electronic book by purchasing one electronic book will be described.

A user who desires to purchase an NFT electronic book logs in to the management server 30. The user requests issuance of a purchase certificate of the electronic book from the management server 30 (the platform business operator). Specifically, in a case where the user performs a predetermined operation (for example, pressing a purchase certificate issuance button), the management server 30 displays a list of electronic books already purchased by the user on the terminal 50. The user selects an electronic book for which the user desires to purchase an NFT electronic book from among the displayed list of electronic books.

In a case where the user selects an electronic book, the management server 30 issues a purchase certificate of the electronic book selected by the user. Specifically, the management server 30 issues an electronic book purchase certificate, which includes information for identifying a purchaser of the electronic book and information related to the electronic book, and whose issuer is the platform business operator.

For example, the management server 30 issues an electronic book purchase certificate, in which a common ID (a wallet address) is set as information for identifying a purchaser of the electronic book, and which includes information related to the electronic book such as a title of the book, a publisher name, a list price, an ISBN code, or the like.

In the first example embodiment, a case where the management server 30 issues an electronic book purchase certificate as an SBT (SoulBound Token) will be described.

First, a person in charge of the platform business operator or the like generates a smart contract for issuing the above-described electronic book purchase certificate and deploys the generated smart contract to a blockchain.

The management server 30, in a case where issuance of an electronic book purchase certificate becomes necessary, calls a function of a smart contract and inputs information necessary for issuance of the electronic book purchase certificate (a common ID, a title of the book, a publisher name, a list price, an ISBN code, and an ID of the platform business operator).

By executing the smart contract, a wallet (a wallet address) of the user is associated with an SBT issued as an electronic book purchase certificate.

In this way, the management server 30 issues an SBT as an electronic book purchase certificate, in which a platform business operator is designated as an issuer and a purchaser of the electronic book is designated as an owner.

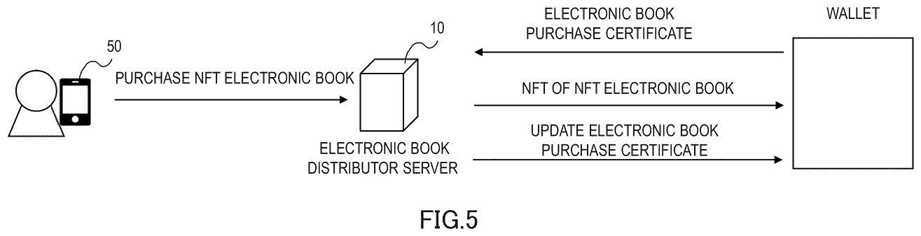

A user who has been issued an electronic book purchase certificate is able to purchase an NFT electronic book. In this case, the user logs in to a marketplace provided by the electronic book distributor server 10 (see FIG. 5).

The electronic book distributor server 10, in a case where the user performs a predetermined operation (for example, pressing an NFT book purchase button), acquires an electronic book purchase certificate from a wallet of the user by using a common ID (a wallet address) of the user. The electronic book distributor server 10 displays, on the terminal 50, a list of electronic books corresponding to the electronic book purchase certificate owned by the user.

The user selects an electronic book for which the user desires to purchase an NFT electronic book from among the displayed list of electronic books.

In a case where the user selects an electronic book, the electronic book distributor server 10 verifies an electronic book purchase certificate corresponding to the electronic book selected by the user. For example, the electronic book distributor server 10 determines whether or not an issuer of the electronic book purchase certificate is a predetermined issuer (determines whether or not the issuer is a reliable platform business operator that has a predetermined contract with the electronic book distributor).

In a case where verification of the electronic book purchase certificate is successful, the electronic book distributor server 10 determines whether or not the user is qualified to purchase an NFT electronic book. Specifically, the electronic book distributor server 10 determines whether or not the user has already purchased the NFT electronic book. It should be noted that determination as to whether or not the user has already purchased the NFT electronic book will be described below.

In a case where the user is qualified to purchase the NFT electronic book (in a case where the user has not purchased the NFT electronic book), the electronic book distributor server 10 sells the NFT electronic book to the user. At that time, the electronic book distributor server 10 may set a price of the NFT electronic book to an amount obtained by multiplying a list price of the corresponding electronic book by a predetermined coefficient.

It should be noted that the electronic book distributor server 10 is able to acquire a list price of the electronic book from the electronic book purchase certificate. Alternatively, the electronic book distributor server 10 may inquire of a server of a publisher of the electronic book (not illustrated in FIG. 3 and the like) about the list price by using an ISBN code of the electronic book.

Here, in a case where an NFT electronic book is sold, a consideration for the sold NFT electronic book is distributed at predetermined ratios to three parties: a publisher, an electronic book distributor, and a platform business operator. For example, B1% of a price of the NFT electronic book is distributed to the publisher, B2% to the electronic book distributor, and B3% to the platform business operator, respectively.

In a case where settlement of a sales price of the NFT electronic book is completed, the electronic book distributor server 10 issues an NFT in which a purchaser of the NFT electronic book is designated as an owner. The electronic book distributor server 10 issues the NFT by using a smart contract.

At that time, the electronic book distributor server 10 sets a price at the time of resale of the NFT electronic book to a list price of the electronic book corresponding to the NFT electronic book. For example, in a case where a list price of the electronic book first purchased by the user is 1000 yen, a price of the NFT electronic book to be resold is also set to 1000 yen.

Further, the electronic book distributor server 10 sets so that a payment resulting from resale of the NFT electronic book is distributed at predetermined ratios to four parties: an owner of the NFT electronic book, a publisher, an electronic book distributor, and a platform business operator. For example, in a case where the NFT electronic book is resold, C1% of a list price of the corresponding electronic book is distributed to the owner of the NFT electronic book, C2% to the publisher, C3% to the electronic book distributor, and C4% to the platform business operator, respectively.

It should be noted that a user who has purchased an electronic book from an electronic book store and has subsequently purchased an NFT electronic book is able to continue browsing the electronic book purchased from the electronic book store even after reselling the purchased NFT electronic book. This is because the electronic book purchased from the electronic book store and the NFT electronic book are different products (services).

In contrast, a user who has purchased a resold NFT electronic book is not able to browse the NFT electronic book after reselling the purchased NFT electronic book. This is because the above-described user loses ownership of the NFT electronic book due to resale of the NFT electronic book.

Here, the electronic book distributor server 10 determines the above distribution ratios so that an amount paid to a publisher in a case where an NFT electronic book is resold becomes greater than an amount paid to the publisher in a case where an electronic book is sold from the electronic book store. Specifically, since a list price of the electronic book and a sales price of the NFT electronic book are the same, a value of the above C2 is set greater than a value of the above A1.

Further, in a case where a user who has purchased an NFT electronic book resells the NFT electronic book, the electronic book distributor server 10 sets a price or the like of the NFT electronic book so that the user is able to obtain a profit by resale of the NFT electronic book. Specifically, the electronic book distributor server 10 determines the above C1 so that an amount distributed by resale of the NFT electronic book becomes greater than a sales price of the NFT electronic book.

In this way, the information processing system (an NFT issuance system) according to the first example embodiment sets distribution ratios of a payment so that a profit is generated for a user in a case where the user who has purchased an NFT electronic book resells the NFT electronic book. By distributing a greater amount of the payment to a reseller of the NFT electronic book, sale and purchase of the NFT electronic book is activated.

In a case where an NFT of an NFT electronic book is issued, a wallet (a wallet address) of a user is associated with the NFT of the NFT electronic book. It should be noted that a main body (digital content) of the NFT electronic book is stored in the electronic book distributor server 10. The user logs in to a marketplace and browses the NFT electronic book (digital content) stored in the electronic book distributor server 10.

Further, the electronic book distributor server 10 reflects a fact that the user has purchased an NFT electronic book (a fact that a purchase right of the NFT electronic book has been exercised) in a wallet of the user. Specifically, the electronic book distributor server 10 writes a fact that the NFT electronic book has been purchased into an electronic book purchase certificate corresponding to the NFT electronic book sold to the user. More specifically, the electronic book distributor server 10 writes a fact that the NFT electronic book has been sold and a sale date and time or the like into metadata of the electronic book purchase certificate.

That is, in a case where the user purchases an NFT electronic book, the electronic book distributor server 10 updates an electronic book purchase certificate corresponding to the sold NFT electronic book. It should be noted that, in a case where the user desires to purchase an NFT electronic book, the electronic book distributor server 10 checks metadata of a corresponding electronic book purchase certificate and determines whether or not the user has already purchased the NFT electronic book. By the determination, the electronic book distributor server 10 determines whether or not the user is qualified (entitled) to purchase the NFT electronic book.

In this way, the management server 30 functions as an apparatus for issuing an electronic book purchase certificate to a user (a reader of an electronic book). That is, the user is able to request issuance of the electronic book purchase certificate from the management server 30 by logging in to an account of the management server 30.

Further, the electronic book distributor server 10 functions as an apparatus for selling an NFT electronic book corresponding to an electronic book purchased by the user. That is, the user is able to exercise a right to purchase an NFT electronic book in a marketplace by receiving issuance of the electronic book purchase certificate from the platform business operator (the management server 30).

Next, details of the individual apparatuses included in the information processing system according to the first example embodiment will be described.

### Management Server

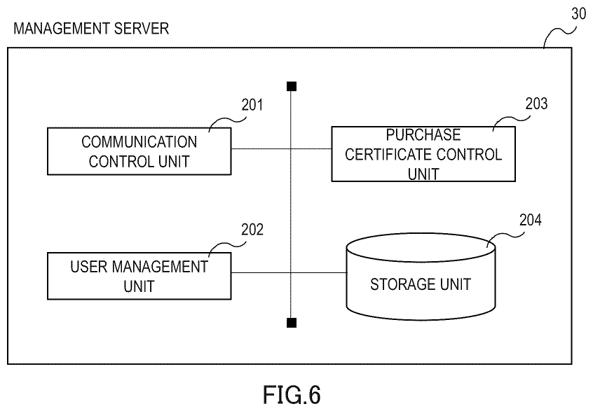

FIG. 6 is a diagram illustrating an example of a processing configuration (processing modules) of the management server 30 according to an example embodiment of the present application. Referring to FIG. 6, the management server 30 includes a communication control unit 201, a user management unit 202, a purchase certificate control unit 203, and a storage unit 204.

The communication control unit 201 is means for controlling communication with other apparatuses. For example, the communication control unit 201 receives data (packets) from the terminal 50. In addition, the communication control unit 201 transmits data to the terminal 50. The communication control unit 201 gives data received from other apparatuses to other processing modules. The communication control unit 201 transmits data acquired from other processing modules to other apparatuses. In this way, other processing modules transmit and receive data to and from other apparatuses via the communication control unit 201. The communication control unit 201 includes a function as a receiving unit that receives data from other apparatuses and a function as a transmitting unit that transmits data to other apparatuses.

The user management unit 202 is means for performing control and management related to a user.

The user management unit 202 acquires information such as a name, a gender, a date of birth, and login information (ID, password) from a user who has accessed a predetermined website (for example, a user registration site). Further, the user management unit 202 acquires a common ID (a wallet address) of the user.

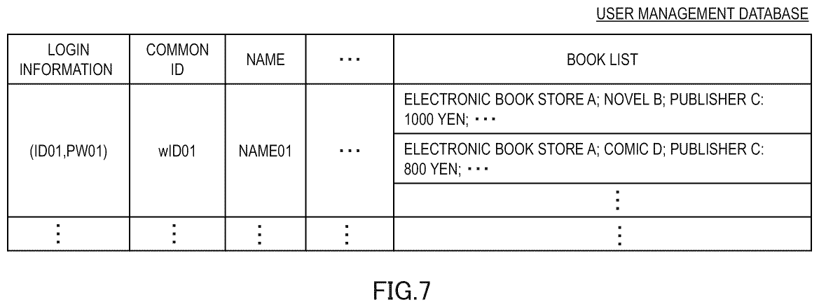

The user management unit 202 stores acquired information such as a name, login information, and a common ID in a user management database (see FIG. 7). It should be noted that the user management database shown in FIG. 7 is an example, and is not meant to limit the items to be stored. For example, biometric information of the user (for example, a face image) may be stored in the user management database.

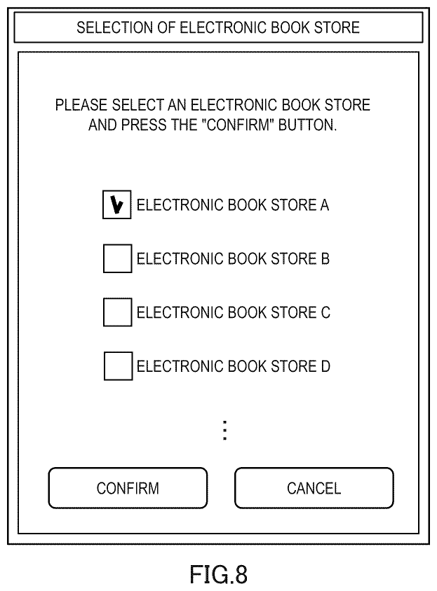

The user management unit 202, in a case where a logged-in user desires to purchase an electronic book, displays a list of electronic book stores on the terminal 50 possessed by the user. For example, the user management unit 202 displays a GUI (Graphical User Interface) as shown in FIG. 8 on the terminal 50 and enables the user to select an electronic book store.

In a case where the user selects an electronic book store, the user management unit 202 redirects a connection destination of the terminal 50 to a login page of the electronic book store selected by the user. At that time, the user management unit 202 transmits a URL for redirection, in which a common ID of the user who has logged in to the account is embedded, to the terminal 50.

The purchase certificate control unit 203 is means for performing control related to a purchase certificate of an electronic book purchased by the user. Specifically, the purchase certificate control unit 203 issues a purchase certificate of the electronic book as an SBT to the user who has purchased the electronic book. More specifically, the purchase certificate control unit 203 issues, to the user, an SBT that proves that the user has purchased the electronic book by using a wallet address of the user.

The purchase certificate control unit 203 receives an electronic book purchase notification from the store server 20. In a case where the electronic book purchase notification is received, the purchase certificate control unit 203 searches the user management database using the common ID (the wallet address) included in the notification as a key and identifies a corresponding entry.

The purchase certificate control unit 203 stores information related to the electronic book purchased by the user (for example, a title of the book, a publisher name, a list price, an ISBN code, or the like) and information of the electronic book store where the electronic book was purchased in a book list field of the identified entry.

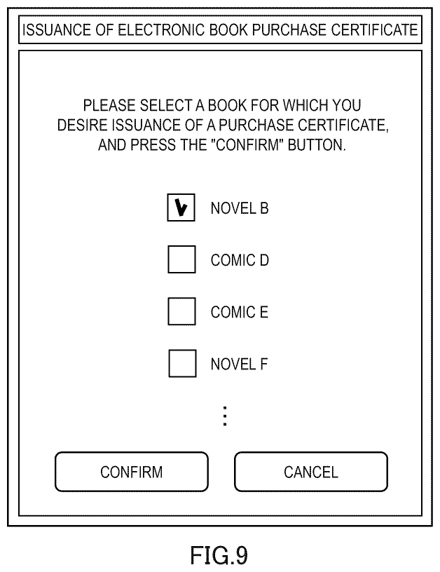

In a case where a user who has logged in to an account desires issuance of an electronic book purchase certificate, the purchase certificate control unit 203 displays a list (a book list) of electronic books already purchased by the user and identifies an electronic book for which the user desires issuance of the purchase certificate. For example, the purchase certificate control unit 203 displays a GUI as shown in FIG. 9 and identifies an electronic book for which the user desires issuance of the electronic book purchase certificate.

In a case where the user identifies an electronic book for which the user desires issuance of an electronic book purchase certificate, the purchase certificate control unit 203 calls a function of a smart contract deployed on a node on a blockchain and issues an SBT for the electronic book purchase certificate.

For example, the purchase certificate control unit 203 inputs a common ID (a wallet address) as an address of an issued party of the SBT and a wallet address of the platform business operator as an ID of an issuer of the SBT into the smart contract. Further, the purchase certificate control unit 203 inputs information related to the purchased electronic book, such as a title of the book, a publisher name, a list price, an ISBN code, or the like, into the smart contract.

The smart contract, by using this information, issues, as the electronic book purchase certificate, an SBT in which the purchaser of the electronic book is designated as an owner and the platform business operator is designated as an issuer and which includes information related to the purchased electronic book in metadata.

It should be noted that issuance of an SBT using the smart contract differs from the gist of the present application disclosed, and thus more detailed description will be omitted.

The storage unit 204 is means for storing information necessary for the operation of the management server 30. For example, the storage unit 204 stores a name of an electronic book store and a URL of a login page in association with each other.

It should be noted that the management server 30 includes a processing module for allowing a user to browse an electronic book already purchased. Detailed description related to the processing module for allowing the user to browse the electronic book already purchased will be omitted.

### Electronic Book Distributor Server

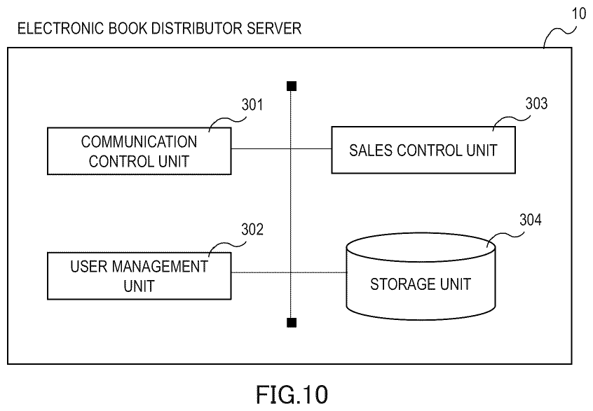

FIG. 10 is a diagram illustrating an example of a processing configuration (processing module) of the electronic book distributor server 10 according to an example embodiment of the present application. Referring to FIG. 10, the electronic book distributor server 10 includes a communication control unit 301, a user management unit 302, a sales control unit 303, and a storage unit 304.

The communication control unit 301 is means for controlling communication with other apparatuses. For example, the communication control unit 301 receives data (packets) from the terminal 50. In addition, the communication control unit 301 transmits data to the terminal 50. The communication control unit 301 gives data received from other apparatuses to other processing modules. The communication control unit 301 transmits data acquired from other processing modules to other apparatuses. In this way, other processing modules transmit and receive data to and from other apparatuses via the communication control unit 301. The communication control unit 301 includes a function as a receiving unit that receives data from other apparatuses and a function as a transmitting unit that transmits data to other apparatuses.

The user management unit 302 is means for performing control and management related to a user.

The user management unit 302 acquires information such as a name, a gender, a date of birth, and login information (ID, password) from a user who has accessed a predetermined website (for example, a user registration site). Further, the user management unit 302 acquires a common ID (a wallet address) of the user. The user management unit 302 stores acquired information such as a name, login information, and a common ID in a predetermined database.

The sales control unit 303 is means for performing control related to sale of an NFT electronic book.

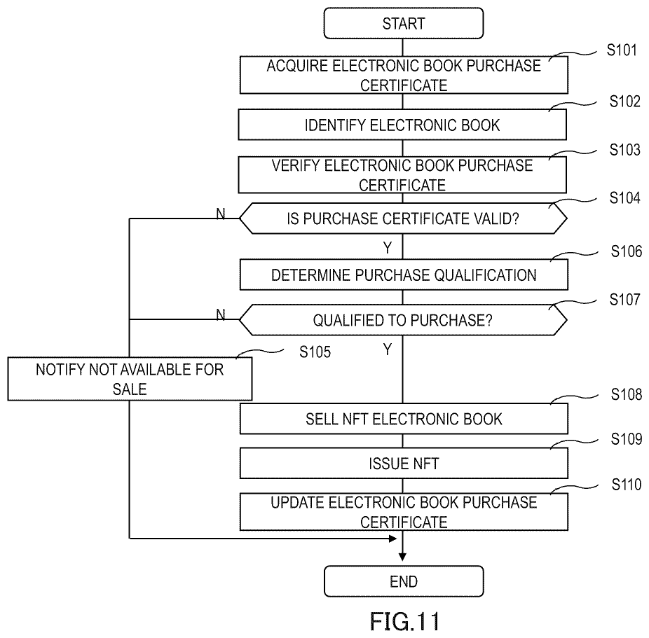

FIG. 11 is a flowchart illustrating an example of an operation of the sales control unit 303 according to an example embodiment disclosed in the present application. The operation of the sales control unit 303 will be described with reference to FIG. 11.

In a case where a user who has logged in to a marketplace desires to purchase an NFT electronic book, the sales control unit 303 connects to a wallet of the user by using a common ID (a wallet address) of the user. The sales control unit 303 acquires an electronic book purchase certificate (an SBT) associated with the wallet of the user (step S101).

The sales control unit 303 acquires information related to the electronic book purchased by the user (for example, a title of the book, a publisher name, a list price, an ISBN code, or the like) from the acquired electronic book purchase certificate. The sales control unit 303 identifies an electronic book corresponding to the NFT electronic book that the user desires to purchase by using the acquired information of the electronic book (step S102).

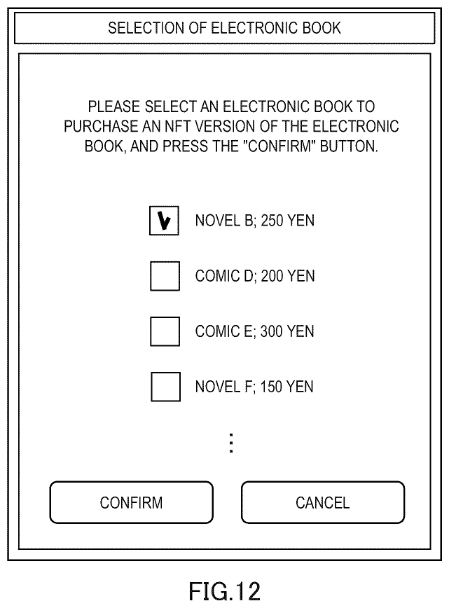

For example, the sales control unit 303 displays a GUI as shown in FIG. 12 on the terminal 50 and identifies an electronic book corresponding to the NFT electronic book that the user desires to purchase. At that time, the sales control unit 303 sets a price of the NFT electronic book to an amount obtained by multiplying a list price of the corresponding electronic book by a predetermined coefficient and presents the price of the NFT electronic book to the user. It should be noted that the sales control unit 303 is able to acquire the list price of the electronic book from the electronic book purchase certificate.

In a case where the selection of the NFT electronic book to be purchased by the user is completed, the sales control unit 303 verifies the electronic book purchase certificate corresponding to the NFT electronic book selected by the user (step S103).

Specifically, the sales control unit 303 performs verification related to an issuer of the electronic book purchase certificate. For example, the sales control unit 303 determines whether or not an ID of the issuer of the electronic book purchase certificate (for example, a wallet address of a platform business operator) is previously registered as an ID of a platform business operator with which a transaction exists.

In a case where the ID of the issuer is registered, the sales control unit 303 determines that the electronic book purchase certificate corresponding to the NFT electronic book the user desires to purchase is valid (determines that verification of the electronic book purchase certificate has succeeded). In a case where the ID of the issuer is not registered, the sales control unit 303 determines that the electronic book purchase certificate corresponding to the NFT electronic book the user desires to purchase is invalid (determines that verification of the electronic book purchase certificate has failed).

In a case where the electronic book purchase certificate is invalid (step S104, No branch), the sales control unit 303 notifies the user that the NFT electronic book cannot be sold (notification of unavailability for sale; step S105).

In a case where the electronic book purchase certificate is valid (step S104, Yes branch), the sales control unit 303 determines whether or not the user is qualified to purchase the NFT electronic book (determination of purchase qualification; step S106).

Specifically, in a case where “NFT electronic book sold” is not described in the electronic book purchase certificate corresponding to the NFT electronic book that the user desires to purchase, the sales control unit 303 determines that the user is qualified to purchase the NFT electronic book. In contrast, in a case where “NFT electronic book sold” is described in the electronic book purchase certificate, the sales control unit 303 determines that the user is not qualified to purchase the NFT electronic book.

In a case where the user is not qualified to purchase the NFT electronic book (step S107, No branch), the sales control unit 303 notifies the user that the NFT electronic book cannot be sold (notification of unavailability for sale; step S105).

In a case where the user is qualified to purchase the NFT electronic book (step S107, Yes branch), the sales control unit 303 sells the NFT electronic book to the user (step S108).

The user pays a price of the NFT electronic book by using cryptocurrency such as Bitcoin or Ethereum. Alternatively, a credit card or electronic money may be used for settlement of the price of the NFT electronic book.

In a case where settlement of the sales price of the NFT electronic book is completed, the sales control unit 303 issues an NFT of the NFT electronic book (step S109). The sales control unit 303 issues the NFT of the NFT electronic book by using a smart contract.

Here, a person in charge of the platform business operator or the like preliminarily creates a smart contract for issuing an NFT of the NFT electronic book and a smart contract that operates in a case where the NFT electronic book is resold. The person in charge or the like deploys the two smart contracts to a blockchain.

The smart contract for NFT issuance issues an NFT that has metadata in which it is explicitly indicated that a purchaser of the NFT electronic book is an owner and that a price (a price at the time of resale) of the NFT electronic book is set to a list price of a corresponding electronic book.

Further, a smart contract for resale distributes a payment obtained at the time of resale of the NFT electronic book at predetermined ratios to four parties: an owner of the NFT electronic book, a publisher, an electronic book distributor, and a platform business operator.

The sales control unit 303 issues an NFT of the NFT electronic book by using a smart contract for NFT issuance.

Further, the sales control unit 303 updates an electronic book purchase certificate corresponding to the NFT electronic book purchased by the user (step S110). Specifically, the sales control unit 303 describes a fact that the user has purchased the NFT electronic book in the corresponding electronic book purchase certificate. For example, the sales control unit 303 writes “June 6, 2024; NFT electronic book sold” into metadata of the electronic book purchase certificate.

In this way, the sales control unit 303 issues an NFT of an NFT electronic book (digital content) to the user in a case where the electronic book purchase certificate has been issued by a legitimate issuer. More specifically, the sales control unit 303 issues, to the user, an NFT of an NFT electronic book having the same content as the electronic book purchased by the user in a case where an issuer of the electronic book purchase certificate (an SBT) is legitimate. Further, the sales control unit 303 issues an NFT of digital content to the user in a case where the user is qualified to receive issuance of the NFT of the digital content.

The storage unit 304 is means for storing information necessary for an operation of the electronic book distributor server 10.

It should be noted that the electronic book distributor server 10 includes a processing module for allowing a user to browse an NFT electronic book already purchased. Detailed description related to the processing module for allowing the user to browse the NFT electronic book already purchased will be omitted.

Further, the electronic book distributor server 10 includes a processing module for allowing a user to resell an NFT electronic book purchased by the user. Detailed description related to the processing module for allowing the NFT electronic book to be resold will be omitted.

### Store Server

Detailed description related to a configuration and operation of the store server 20 will be omitted. The store server 20 may transmit an “electronic book purchase notification” related to the sold electronic book to the management server 30 after selling an electronic book to a user.

### Wallet Server

Detailed description related to a configuration and operation of the wallet server 40 will be omitted. The wallet server 40 may issue a wallet address to a user.

### Terminal

Examples of the terminal 50 include a portable terminal device such as a smartphone, a portable phone, a game console, or a tablet and a computer (a personal computer or a laptop computer). The terminal 50 can be any equipment or device as long as the terminal 50 can accept an operation by a user and can communicate with the management server 30 or the like. Further, since the configuration and the like of the terminal 50 are obvious to those skilled in the art, detailed description related to the terminal 50 will be omitted.

### System Operation

Next, operations of the information processing system according to the first example embodiment will be described.

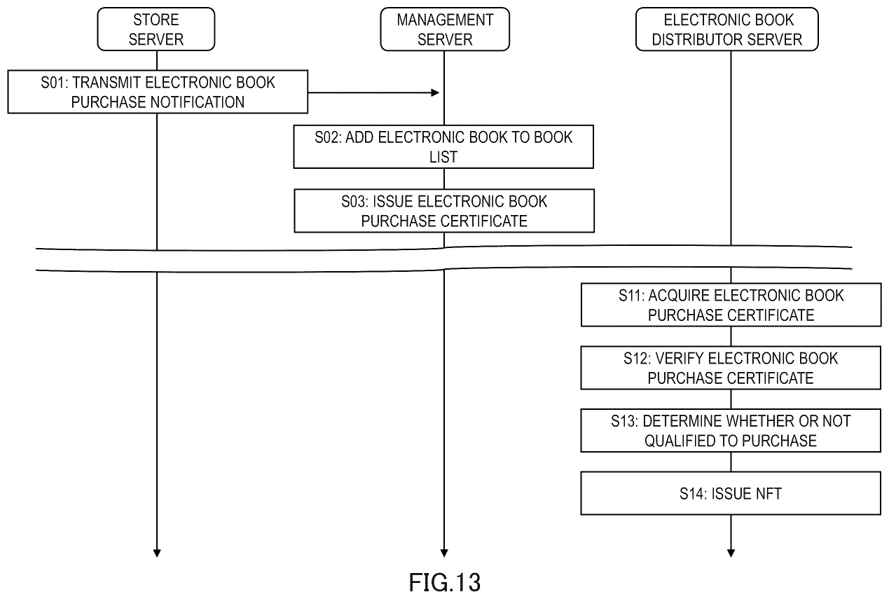

FIG. 13 is a sequence diagram illustrating an example of an operation of the information processing system according to an example embodiment disclosed in the present application. The operation of the information processing system according to the first example embodiment will be described with reference to FIG. 13.

In a case where the store server 20 sells an electronic book to a user, the store server 20 transmits an electronic book purchase notification including a common ID (a wallet address) of the user and information related to the sold electronic book to the management server 30 (step S01).

The management server 30 identifies a user who has purchased the electronic book by using the common ID and adds the purchased electronic book to a book list of the identified user (step S02).

The management server 30 issues a purchase certificate of the electronic book purchased by the user in response to a request from the user (step S03).

In a case where the user desires to purchase an NFT electronic book, the electronic book distributor server 10 acquires an electronic book purchase certificate of the electronic book corresponding to the NFT electronic book (step S11).

The electronic book distributor server 10 performs verification of the acquired electronic book purchase certificate and determines whether or not the user is qualified to purchase the NFT electronic book (steps S12 and S13).

In a case where the electronic book purchase certificate is valid and the user is qualified to purchase the NFT electronic book, the electronic book distributor server 10 issues an NFT of the NFT electronic book (step S14).

Next, variations according to the first example embodiment will be described.

### Variation 1

In the above-described example embodiment, a case where the management server 30 issues an electronic book purchase certificate in response to a request from a user has been described. However, the management server 30 may issue the electronic book purchase certificate in response to reception of the electronic book purchase notification from the store server 20. That is, the purchase certificate control unit 203 of the management server 30 may automatically issue the electronic book purchase certificate.

### Variation 2

In the above-described example embodiment, a case where a user is able to purchase one NFT electronic book by purchasing one electronic book has been described. However, the user may be able to purchase a plurality of NFT electronic books by purchasing one electronic book.

In this case, a publisher may set the number of NFT electronic books that the user is able to purchase for each electronic book. Specifically, in a case where the electronic book is provided to the electronic book store via the electronic book distributor, an upper limit of the number of purchases of the NFT electronic book set by the publisher is notified to the electronic book store.

In a case where the electronic book store sells the electronic book to the user, the corresponding store server 20 transmits an electronic book purchase notification including an upper limit of the number of purchases related to the NFT electronic book set for the sold electronic book to the management server 30.

The purchase certificate control unit 203 of the management server 30 issues an electronic book purchase certificate in which the notified upper limit of the number of purchases is set.

The sales control unit 303 of the electronic book distributor server 10 acquires the number of times the user has purchased the NFT electronic book from the electronic book purchase certificate corresponding to the NFT electronic book the user desires to purchase.

The sales control unit 303 determines that the user is qualified to purchase the NFT electronic book in a case where the acquired number of purchases has not reached the upper limit described in the electronic book purchase certificate.

The sales control unit 303 updates the electronic book purchase certificate while incrementing the number of times the user has purchased the NFT electronic book each time the NFT electronic book is sold to the user.

In this way, the electronic book distributor server 10 increments the number of times of purchases of the digital content by the user, which is described in the electronic book purchase certificate, each time an NFT of the digital content (NFT electronic book) is issued to the user. The electronic book distributor server 10 determines that the user is qualified to receive issuance of the NFT of the digital content in a case where the number of purchases of the digital content described in the electronic book purchase certificate has not reached the upper limit set for the digital content.

It should be noted that the publisher may sell an electronic book for which sale of the NFT electronic book is prohibited. That is, the information processing system may handle both an electronic book for which sale of the NFT electronic book is permitted and an electronic book for which sale of the NFT electronic book is prohibited.

An electronic book purchase certificate corresponding to an electronic book for which sale of the NFT electronic book is prohibited is set to indicate that sale of the NFT electronic book is prohibited. Alternatively, the management server 30 may refuse to issue an electronic book purchase certificate corresponding to an electronic book for which sale of the NFT electronic book is prohibited.

### Variation 3

In a case where an upper limit of the number of purchases is not set in an electronic book purchase certificate, the electronic book distributor server 10 may inquire of a publisher of an electronic book corresponding to an NFT electronic book that the user desires to purchase about the upper limit of the number of purchases.

Specifically, a sales control unit 303 of the electronic book distributor server 10 acquires an ISBN code from an electronic book purchase certificate corresponding to the NFT electronic book that the user desires to purchase and transmits the acquired ISBN code to a server of the publisher. The server of the publisher identifies the electronic book purchased by the user based on the received ISBN code and transmits the upper limit of the number of purchases set for the identified electronic book to the electronic book distributor server 10.

The sales control unit 303 compares the number of purchases (the number of times the user has purchased the NFT electronic book) described in the electronic book purchase certificate with the upper limit of the number of purchases notified from the server of the publisher and determines whether or not the user is qualified to purchase the NFT electronic book.

### Variation 4

In the above-described example embodiment, a case where the management server 30 issues an electronic book purchase certificate as an SBT has been described. However, the management server 30 may issue an electronic book purchase certificate in another format.

Specifically, the purchase certificate control unit 203 of the management server 30 may issue a digital certificate using a Public Key Infrastructure (PKI) as an electronic book purchase certificate. Alternatively, the purchase certificate control unit 203 may issue Verifiable Credentials (VCs) that enable online verification of their content as electronic book purchase certificates.

In a case where a digital certificate or Verifiable Credentials are issued as electronic book purchase certificates, the electronic book distributor server 10 verifies electronic signatures attached to the certificates. In a case where verification of the electronic signatures succeeds and the user is qualified to purchase the NFT electronic book, the electronic book distributor server 10 issues an NFT of the NFT electronic book.

Further, in a case where a digital certificate based on PKI or Verifiable Credentials are issued as electronic book purchase certificates, the certificates may be managed by a wallet of the user or may be managed by an account of the management server 30 or the electronic book distributor server 10.

In a case where the management server 30 manages the electronic book purchase certificate of the user, the electronic book distributor server 10 requests the management server 30 to provide the electronic book purchase certificate. Specifically, the sales control unit 303 of the electronic book distributor server 10 transmits a common ID of the user to the management server 30. The management server 30 identifies a user who desires to purchase the NFT electronic book by using the common ID and transmits the electronic book purchase certificate stored in the account of the identified user to the electronic book distributor server 10.

In a case where the electronic book distributor server 10 manages the electronic book purchase certificate of the user, the purchase certificate control unit 203 of the management server 30 transmits the electronic book purchase certificate issued together with the common ID of the user to the electronic book distributor server 10. The user management unit 302 of the electronic book distributor server 10 identifies the user who has received issuance of the electronic book purchase certificate by using the common ID and stores the received electronic book purchase certificate in an account of the identified user.

### Variation 5

A user who has purchased an NFT electronic book may be granted a right to use data related to the NFT electronic book in a metaverse (a virtual space). Specifically, the user is able to arrange the purchased NFT electronic books in his or her room in the virtual space and read an NFT electronic book. Alternatively, the user may resell the NFT electronic book in the virtual space. That is, the user who has purchased the NFT electronic book may use the NFT electronic book as content for a bookshelf, a personal bookstore, or a personal library in the metaverse space.

In this case, the user may request a server that provides the metaverse platform to connect to a wallet of the user and acquire data related to the NFT electronic book (for example, data related to a design of a spine of the electronic book or the like).

### Variation 6

In the above-described example embodiment, a case where a common ID of a user (for example, a wallet address) is set in each of the electronic book distributor server 10, the store server 20, and the management server 30 has been described. However, the common ID (the wallet address) may not be set in some servers. For example, the common ID may not be set in the store server 20 that sells the electronic book.

In this case, the management server 30 may integrally manage account information of each electronic book store. Specifically, the user who has logged in to each electronic book store requests the store server 20 to link an account of the electronic book store with an account of the management server 30. The store server 20 that has received the request for account linking transmits identification information of the electronic book store, information for identifying the user (for example, a combination of a name and a date of birth), and account information (for example, a user ID) to the management server 30.

The management server 30 searches the user management database by using information for identifying the user as a key and identifies a corresponding entry. The management server 30 stores the identification information of the electronic book store and the account information in association with the identified entry. For example, the management server 30 stores information such as “electronic book store A: ABC1234” in the user management database.

Further, each store server 20 notifies the management server 30 of identification information of an electronic book store and account information of the user at the time of transmitting an electronic book purchase notification to the management server 30. For example, in a case where a user whose user ID is “ABC1234” purchases an electronic book at electronic book store A, the store server 20 transmits an electronic book purchase notification including identification information of the electronic book store A and the user ID “ABC1234” to the management server 30. The management server 30 identifies a purchaser of the electronic book based on the notified information (the identification information of the electronic book store, the account information).

The management server 30 stores information of the purchased electronic book in an account of the identified purchaser of the electronic book.

In this way, in the information processing system according to the first example embodiment, a user who has purchased an electronic book may be identified (distinguished) without using a common ID (a wallet address) of the user. That is, the management server 30 may store account information of another company (an electronic book store) whose account has been linked (store account information in a concealed state), thereby identifying the purchaser of the electronic book.

### Variation 7

The system configuration shown in FIG. 3 is an example. For example, the management server 30 operated by the platform business operator may provide a wallet service. That is, the management server 30 may include a function of the wallet server 40.

Alternatively, in the above-described example embodiment, a case where the electronic book distributor server 10 operated by the electronic book distributor issues an NFT of an NFT electronic book has been described. However, the management server 30 may issue the NFT of the NFT electronic book. That is, the management server 30 may include a function of the electronic book distributor server 10.

In other words, the information processing system according to the example embodiment disclosed in the present application only needs to include a certificate issuance means and an NFT issuance means. The certificate issuance means is means for issuing a purchase certificate related to a product or service purchased by the user. The NFT issuance means is means for issuing, to the user, an NFT (Non-Fungible Token) corresponding to digital content related to a product or service purchased by the user, in a case where verification of the issued purchase certificate succeeds.

As described above, the information processing system according to the first example embodiment issues a purchase certificate in accordance with a purchase of a product or service by the user. The information processing system issues an NFT of digital content corresponding to a product or service purchased by the user in a case where verification of the purchase certificate issued to the user succeeds. Since the NFT indicates ownership of the digital content by the user, the digital content can be a subject of sale and purchase. That is, the information processing system according to the example embodiment disclosed in the present application can realize distribution of digital content corresponding to a product or service purchased by the user.

Here, an electronic book sold in an electronic book store has inconveniences for a user. Specifically, a user who has purchased an existing book in paper form is able to continue browsing the book without being affected by the existence or nonexistence of the bookstore where the book was purchased. In contrast, in a case where the electronic book store where an electronic book was purchased is closed, the user who purchased the electronic book may not be able to browse the purchased electronic book.

The information processing system according to the example embodiment disclosed in the present application solves the above problem by allowing the user who has purchased an electronic book to purchase an NFT electronic book. That is, the electronic book and the NFT electronic book are different content, and the user is able to browse the NFT electronic book without being affected by the existence or nonexistence of the electronic book store.

Further, in a case where the user sells the purchased NFT electronic book, an amount larger than the purchase price of the NFT electronic book is distributed to the user. As a result, it is unlikely that the user who purchased the NFT electronic book will suffer an economic loss. Therefore, the user is more motivated to purchase an NFT electronic book.

Further, a book in paper form is subject to sale and purchase as a secondhand good. In contrast, an electronic book is not subject to sale and purchase. Although the list price of a book in paper form and an electronic book is the same due to a resale price maintenance system for books, the user's motivation to purchase an electronic book may decrease because the purchased product cannot be sold or purchased.

In contrast, in the information processing system according to the example embodiment disclosed in the present application, the user is able to sell the NFT electronic book in the same manner as a book in paper form. Further, by selling the NFT electronic book, a profit is generated for the user. Furthermore, even after selling the NFT electronic book, the user is able to continue browsing the electronic book. In this way, many advantages are provided to the user who has purchased the electronic book and the NFT electronic book, and the market for electronic books and NFT electronic books becomes more active.

Further, the information system according to the example embodiment disclosed in the present application issues an NFT of an NFT electronic book such that, in a case where the NFT electronic book is resold, a larger consideration than the consideration acquired by the publisher through the sale of the electronic book is paid to the publisher. As a result, in a case where the NFT electronic book is resold, a larger consideration than that for the sale of the electronic book is paid to the publisher. That is, although no advantage is generated for the publisher even if a book in paper form is sold and purchased, a significant advantage is generated for the publisher in the sale and purchase of the NFT electronic book. As a result, a motivation to expand the market for NFT electronic books may also arise for the publisher.

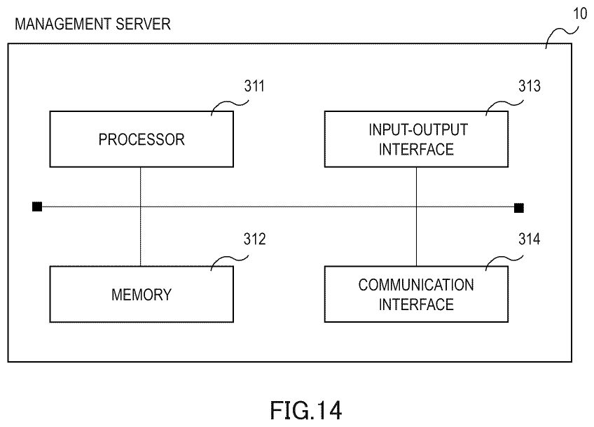

Next, a hardware configuration of an individual apparatus that constitutes the information processing system will be described. FIG. 14 is a diagram illustrating an example of a hardware configuration of the management server 30.

The management server 30 can be configured by an information processing apparatus (a so-called computer) and has a configuration illustrated as an example in FIG. 14. For example, the management server 30 includes a processor 311, a memory 312, an input-output interface 313, a communication interface 314 or the like. The above-described components such as the processor 311 are connected via an internal bus or the like and are configured to be capable of communicating with each other.

However, the configuration illustrated in FIG. 14 is not intended to limit the hardware configuration of the management server 30. The management server 30 may include hardware not illustrated or may be configured without the input-output interface 313 if desired. In addition, the number of components, such as the number of processors 311, included in the management server 30 is not limited to the example illustrated in FIG. 14. For example, a plurality of processors 311 may be included in the management server 30.

For example, the processor 311 is a programmable device such as a CPU (Central Processing Unit), an MPU (Micro Processing Unit), or a DSP (Digital Signal Processor). Alternatively, the processor 311 may be a device such as an FPGA (Field Programmable Gate Array) or an ASIC (Application Specific Integrated Circuit). The processor 311 executes various kinds of programs including an operating system (OS).

The memory 312 is a RAM (Random Access Memory), a ROM (Read-Only Memory), an HDD (Hard Disk Drive), an SSD (Solid State Drive), or the like. The memory 312 stores an OS program, an application program, and various kinds of data.

The input-output interface 313 is an interface for a display apparatus and an input apparatus not illustrated. The display apparatus is, for example, a liquid crystal display or the like. For example, the input apparatus is an apparatus that receives user operations, and examples of the input apparatus include a keyboard and a mouse.

The communication interface 314 is a circuit, a module, or the like for performing communication with other apparatuses. For example, the communication interface 314 includes a NIC (Network Interface Card) or the like.

The functions of the management server 30 are realized by various kinds of processing modules. The processing modules are realized, for example, by causing the processor 311 to execute a program stored in the memory 312. In addition, this program can be recorded in a computer-readable storage medium. The storage medium may be a non-transient (non-transitory) storage medium, such as a semiconductor memory, a hard disk, a magnetic recording medium, or an optical recording medium. That is, the present invention can be embodied as a computer program product. In addition, the above program may be updated by downloading a program via a network or by using a storage medium in which a program is stored. In addition, the above processing modules may be realized by semiconductor chips.

It should be noted that the electronic book distributor server 10, the store server 20, the wallet server 40, and the like can also be configured by information processing apparatuses in the same manner as the management server 30, and since the specific hardware configurations of the electronic book distributor server 10, the store server 20, the wallet server 40, and the like are not different from that of the management server 30, a detailed description thereof will be omitted.

The management server 30, which is an information processing apparatus, includes a computer and can realize its functions by causing the computer to execute a program. In addition, the management server 30 executes a control method of the management server 30 by the program. Similarly, the electronic book distributor server 10 includes a computer, and the functions of the electronic book distributor server 10 can be realized by causing the computer to execute a program. In addition, the electronic book distributor server 10 executes a control method of the electronic book distributor server 10 by using this program.

### Variations

The configurations, operations, and so on of the information processing system according to the above example embodiments are examples and do not limit the present system configuration, and so on.

In the above-described example embodiment, the configuration and operation of the information processing system (NFT issuance system) have been described by taking an electronic book as an example of a product (service) to be purchased by the user. However, the information processing system may issue, as an NFT, digital content corresponding to another product or service. For example, the information processing system may issue, as an NFT, digital content corresponding to a tangible object such as a book in paper form, a CD (Compact Disc), a DVD (Digital Versatile Disc), a figure, or a vehicle. Alternatively, the information processing system may issue, as an NFT, digital content corresponding to an intangible object such as an electronic book or music data.

In the above-described example embodiment, a case where the electronic book distributor server 10 sells an NFT electronic book having the same content as an electronic book purchased by the user has been described. However, the electronic book distributor server 10 can sell arbitrary digital content corresponding to a product or service purchased by the user (or related to a product or service purchased by the user). For example, a user who has purchased a figure may purchase 3D data or image data (illustrations) of the figure. The electronic book distributor server 10 may issue an NFT related to the 3D data or the like of the figure.

In the above-described example embodiment, it has been described that the user logs in to each electronic book store via the management server 30. However, the user may log in directly to the electronic book store. In this case, the store server 20 may transmit an electronic book purchase notification to the management server 30 each time the user purchases an electronic book. Alternatively, the user who has logged in to the electronic book store may request the store server 20 to transmit the electronic book purchase notification.

In the above-described example embodiment, a case where the management server 30 issues an electronic book purchase certificate has been described. However, the store server 20 corresponding to the electronic book store at which the user has purchased the electronic book may issue the electronic book purchase certificate.

In the above-described example embodiment, a case where a wallet address is used as a common ID of the user has been described. However, other information may be used as the common ID of the user. For example, a digital signature (a digital ID) or a decentralized identifier (DID; Decentralized Identifier) may be used as the common ID of the user. Similarly, not only a wallet address but also a digital signature (a digital ID) or a decentralized identifier (DID) may be used for the ID of the platform business operator.

In the above-described example embodiment, a case has been described where an electronic book purchase notification transmitted by the store server 20 and an electronic book purchase certificate issued by the management server 30 include information related to an electronic book purchased by the user, such as a title of the book, a publisher name, a list price, an ISBN code, or the like. However, it is sufficient that the electronic book purchase notification or the electronic book purchase certificate includes an ISBN code as information for identifying the electronic book purchased by the user. The management server 30 or the electronic book distributor server 10 may acquire information of a book corresponding to the transmitted ISBN code (such as a title of the book and a list price) by transmitting the ISBN code to a server of the publisher or another server.

In the above-described example embodiment, a case has been described where, in a case where the user desires to purchase an NFT electronic book, the electronic book distributor server 10 displays a list of electronic books shown in FIG. 12 and verifies an electronic book purchase certificate corresponding to the electronic book selected by the user and determines whether or not the user has qualification to purchase. However, the electronic book distributor server 10 may perform verification and determination of qualification for purchase in advance for each of a plurality of electronic book purchase certificates owned by the user, and may display a list of electronic books for which the user is able to purchase NFT electronic books. That is, the electronic book distributor server 10 may exclude an NFT electronic book that the user is unable to purchase and may enable selection of an NFT electronic book (selection of an NFT electronic book to be purchased) by the user by using a GUI similar to that shown in FIG. 12.

In the above-described example embodiment, a case has been described where the electronic book distributor server 10 stores main data (actual data) of an NFT electronic book. However, the main data of the NFT electronic book may be stored in a server of the publisher or may be stored in the management server 30. Alternatively, the main data of the NFT electronic book may be stored in a blockchain.

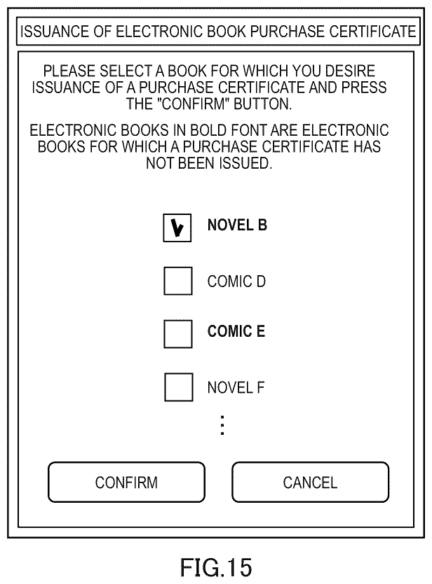

The management server 30 may manage an issuance status of an electronic book purchase certificate (a purchase status of an NFT electronic book) in an account of each user. By managing an issuance status of an electronic book purchase certificate of a user and the like, the management server 30 may display, in the GUI shown in FIG. 9, an electronic book without an issued certificate and an electronic book with an issued certificate in a manner that allows the user to distinguish between them. For example, the management server 30 may display a notation of “certificate issued” near a title of an electronic book for which an electronic book purchase certificate has been issued. Alternatively, the management server 30 may display a title of an electronic book for which an electronic book purchase certificate has not been issued in bold (see FIG. 15).

Alternatively, the management server 30 may display a spine of an electronic book in place of or in addition to a title of the electronic book purchased by the user at the time of displaying the GUI shown in FIG. 9. In this case, the management server 30 transmits an ISBN code of each electronic book purchased by the user to a server of a publisher or the like and acquires a design of a spine. For example, the management server 30 may display, on the terminal 50, a GUI that lists books stored in a bookshelf of the user by using the acquired spines and allows the user to select an electronic book to be subjected to issuance of an electronic book purchase certificate from among the listed books.

The management server 30 may perform authentication of the user before issuing an electronic book purchase certificate. For example, in a case where biometric authentication of the user who desires issuance of an electronic book purchase certificate succeeds, the management server 30 may display a GUI such as that shown in FIG. 9 or FIG. 15 on the terminal 50. In this case, the management server 30 acquires biometric information (for example, a face image) of the user (an account holder) at the time of generation of the account of the user. In a case where the user (the user who has logged in to the account) desires issuance of the electronic book purchase certificate, the management server 30 acquires biometric information of the user via the terminal 50. For example, the management server 30 instructs the user to take a selfie by using the terminal 50. The terminal 50 transmits the acquired biometric information to the management server 30. The management server 30 determines that authentication of the user who desires issuance of the electronic book purchase certificate has succeeded in a case where the biometric information stored in the account substantially matches the biometric information acquired from the terminal 50. In a case where authentication of the user who desires issuance of the electronic book purchase certificate succeeds, the management server 30 displays GUIs shown in FIG. 9 or FIG. 15 on the terminal 50.

In the flowcharts and sequence diagrams used in the above description, a plurality of steps (processes) are sequentially described. However, the order of the execution of the steps performed in the individual example embodiment is not limited to the described order. In the individual example embodiment, the order of the illustrated steps may be changed to the extent that a problem is not caused on the content of the individual example embodiment. For example, individual processes may be executed in parallel.

The above example embodiments have been described in detail to facilitate the understanding of the present application disclosed and not to mean that all the configurations described above are needed. In addition, if a plurality of example embodiments have been described, each of the example embodiments may be used individually or a plurality of example embodiments may be used in combination. For example, part of a configuration according to one example embodiment may be replaced by a configuration according to another example embodiment. For example, a configuration according to one example embodiment may be added to a configuration according to another example embodiment. In addition, addition, deletion, or replacement is possible between part of a configuration according to one example embodiment and another configuration.

The industrial applicability of the present invention has been made apparent by the above description. That is, the present invention is suitably applicable, for example, to an information processing system that sells electronic books and NFT electronic books or the like.

A part or the entirety of the example embodiments described above may be described as in the following supplementary notes, but is not limited to the followings.

### Supplementary Note 1

A system, including:
a certificate issuance means that issues a purchase certificate related to a product or service purchased by a user; and
an NFT (Non-Fungible Token) issuance means that issues, in a case where a verification of the issued purchase certificate succeeds, to the user, an NFT of digital content corresponding to the product or service purchased by the user.

### Supplementary Note 2

The system according to supplementary note 1, wherein the NFT issuance means issues the NFT of digital content to the user in a case where the purchase certificate has been issued by a legitimate issuer.

### Supplementary Note 3

The system according to supplementary note 2, wherein the NFT issuance means issues the NFT of digital content to the user in a case where the user is qualified to receive an issuance of the NFT of the digital content.

### Supplementary Note 4

The system according to supplementary note 3, wherein the NFT issuance means increments a number of purchases of the digital content by the user, which is described in the purchase certificate, each time the NFT of the digital content is issued to the user.

### Supplementary Note 5

The system according to supplementary note 4, wherein the NFT issuance means determines that the user is qualified to receive the issuance of the NFT of the digital content in a case where the number of purchases of the digital content described in the purchase certificate has not reached an upper limit of the number of purchases set for the digital content.

### Supplementary Note 6

The system according to any one of supplementary notes 1 to 5, wherein the certificate issuance means issues the purchase certificate of an electronic book as an SBT (SoulBound Token) to the user who has purchased the electronic book, and
wherein the NFT issuance means issues, to the user, the NFT of an NFT electronic book having same content as the electronic book purchased by the user in a case where an issuer of the SBT is legitimate.

### Supplementary Note 7

The system according to supplementary note 6, wherein the NFT issuance means issues the NFT of the NFT electronic book such that, in a case where the NFT electronic book is resold, a larger consideration than a consideration acquired by a publisher through a sale of the electronic book is paid to the publisher.

### Supplementary Note 8

A method performed in a system, the method including:
a certificate issuance step that issues a purchase certificate related to a product or service purchased by a user; and
an NFT (Non-Fungible Token) issuance step that issues, in a case where a verification of the issued purchase certificate succeeds, to the user, an NFT of digital content corresponding to the product or service purchased by the user.

### Supplementary Note 9

The method according to supplementary note 8, wherein the NFT issuance step issues the NFT of digital content to the user in a case where the purchase certificate has been issued by a legitimate issuer.

### Supplementary Note 10

The method according to supplementary note 9, wherein the NFT issuance step issues the NFT of digital content to the user in a case where the user is qualified to receive an issuance of the NFT of the digital content.

### Supplementary Note 11

The method according to supplementary note 10, wherein the NFT issuance step increments a number of purchases of the digital content by the user, which is described in the purchase certificate, each time the NFT of the digital content is issued to the user.

### Supplementary Note 12

The method according to supplementary note 11, wherein the NFT issuance step determines that the user is qualified to receive the issuance of the NFT of the digital content in a case where the number of purchases of the digital content described in the purchase certificate has not reached an upper limit of the number of purchases set for the digital content.

### Supplementary Note 13

The method according to any one of supplementary notes 8 to 12, wherein the certificate issuance step issues the purchase certificate of an electronic book as an SBT (SoulBound Token) to the user who has purchased the electronic book, and
wherein the NFT issuance step issues, to the user, the NFT of an NFT electronic book having same content as the electronic book purchased by the user in a case where an issuer of the SBT is legitimate.

### Supplementary Note 14

The method according to supplementary note 13, wherein the NFT issuance step issues the NFT of the NFT electronic book such that, in a case where the NFT electronic book is resold, a larger consideration than a consideration acquired by a publisher through a sale of the electronic book is paid to the publisher.

### Supplementary Note 15

A program causing a computer to perform processing for:
a certificate issuance processing that issues a purchase certificate related to a product or service purchased by a user; and
an NFT (Non-Fungible Token) issuance processing that issues, in a case where a verification of the issued purchase certificate succeeds, to the user, an NFT of digital content corresponding to the product or service purchased by the user.

### Supplementary Note 16

The program according to supplementary note 15, wherein the NFT issuance processing issues the NFT of digital content to the user in a case where the purchase certificate has been issued by a legitimate issuer.

### Supplementary Note 17

The program according to supplementary note 16, wherein the NFT issuance processing issues the NFT of digital content to the user in a case where the user is qualified to receive an issuance of the NFT of the digital content.

### Supplementary Note 18

The program according to supplementary note 17, wherein the NFT issuance processing increments a number of purchases of the digital content by the user, which is described in the purchase certificate, each time the NFT of the digital content is issued to the user.

### Supplementary Note 19

The program according to supplementary note 18, wherein the NFT issuance processing determines that the user is qualified to receive the issuance of the NFT of the digital content in a case where the number of purchases of the digital content described in the purchase certificate has not reached an upper limit of the number of purchases set for the digital content.

### Supplementary Note 20

The program according to any one of supplementary notes 15 to 19, wherein the certificate issuance processing issues the purchase certificate of an electronic book as an SBT (SoulBound Token) to the user who has purchased the electronic book, and
wherein the NFT issuance processing issues, to the user, the NFT of an NFT electronic book having same content as the electronic book purchased by the user in a case where an issuer of the SBT is legitimate.

### Supplementary Note 21

The program according to supplementary note 20, wherein the NFT issuance processing issues the NFT of the NFT electronic book such that, in a case where the NFT electronic book is resold, a larger consideration than a consideration acquired by a publisher through a sale of the electronic book is paid to the publisher.

### Supplementary Note 22

A server apparatus, including:
a receiving means that receives, from a store server operated by an electronic book store where a user has purchased an electronic book, an electronic book purchase notification including a wallet address of the user; and
an issuance means that issues, to the user, a purchase certificate that proves that the user has purchased the electronic book by using the wallet address of the user.

### Supplementary Note 23

A control method of a server apparatus, the control method including: receiving, from a store server operated by an electronic book store where a user has purchased an electronic book, an electronic book purchase notification including a wallet address of the user; and
issuing, to the user, a purchase certificate that proves that the user has purchased the electronic book by using the wallet address of the user.

### Supplementary Note 24

A program causing a computer mounted on a server apparatus to perform processing for:
receiving, from a store server operated by an electronic book store where a user has purchased an electronic book, an electronic book purchase notification including a wallet address of the user; and
issuing, to the user, a purchase certificate that proves that the user has purchased the electronic book by using the wallet address of the user.

Furthermore, all or part of the configurations described in supplementary note 2 to supplementary note 7, which depend on supplementary note 1, may also depend on supplementary note 8 and supplementary note 15 in the same manner as supplementary note 2 to supplementary note 7. Furthermore, not limited to supplementary note 1, supplementary note 8, and supplementary note 15, within the scope that does not deviate from the embodiments described above, all or part of the configurations described as supplementary notes may similarly depend on various hardware, software, various recording means for recording software, or systems.

The entire disclosure of the above patent literature is incorporated herein by reference thereto. While the example embodiments of the present invention have thus been described, the present invention is not limited to these example embodiments. It is to be understood to those skilled in the art that these example embodiments are only examples and that various variations are possible without departing from the scope and spirit of the present invention. That is, the present invention of course includes various variations and modifications that could be made by those skilled in the art in accordance with the overall disclosure including the claims and the technical concept.

The previous description of embodiments is provided to enable a person skilled in the art to make and use the present disclosure.

Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed disclosure even if the claims are amended during prosecution.

What is claimed is:

1. A system, comprising:
at least one memory storing a set of instructions; and
at least one processor configured to execute the set of instructions to:
issue a purchase certificate related to a product or service purchased by a user; and
issue, in a case where a verification of the issued purchase certificate succeeds, to the user, an NFT (Non-Fungible Token) of digital content corresponding to the product or service purchased by the user.

2. The system according to claim 1, wherein
the at least one processor is further configured to execute the set of instructions to issue the NFT of digital content to the user in a case where the purchase certificate has been issued by a legitimate issuer.

3. The system according to claim 2, wherein
the at least one processor is further configured to execute the set of instructions to issue the NFT of digital content to the user in a case where the user is qualified to receive an issuance of the NFT of the digital content.

4. The system according to claim 3, wherein
the at least one processor is further configured to execute the set of instructions to increment a number of purchases of the digital content by the user, which is described in the purchase certificate, each time the NFT of the digital content is issued to the user.

5. The system according to claim 4, wherein
the at least one processor is further configured to execute the set of instructions to determine that the user is qualified to receive the issuance of the NFT of the digital content in a case where the number of purchases of the digital content described in the purchase certificate has not reached an upper limit of the number of purchases set for the digital content.

6. The system according to claim 1, wherein
the at least one processor is further configured to execute the set of instructions to:
issue the purchase certificate of an electronic book as an SBT (SoulBound Token) to the user who has purchased the electronic book; and
issue, to the user, the NFT of an NFT electronic book having same content as the electronic book purchased by the user in a case where an issuer of the SBT is legitimate.

7. The system according to claim 2, wherein
the at least one processor is further configured to execute the set of instructions to:
issue the purchase certificate of an electronic book as an SBT (SoulBound Token) to the user who has purchased the electronic book; and
issue, to the user, the NFT of an NFT electronic book having same content as the electronic book purchased by the user in a case where an issuer of the SBT is legitimate.

8. The system according to claim 3, wherein the at least one processor is further configured to execute the set of instructions to:
issue the purchase certificate of an electronic book as an SBT (SoulBound Token) to the user who has purchased the electronic book; and
issue, to the user, the NFT of an NFT electronic book having same content as the electronic book purchased by the user in a case where an issuer of the SBT is legitimate.

9. The system according to claim 4, wherein
the at least one processor is further configured to execute the set of instructions to:
issue the purchase certificate of an electronic book as an SBT (SoulBound Token) to the user who has purchased the electronic book; and
issue, to the user, the NFT of an NFT electronic book having same content as the electronic book purchased by the user in a case where an issuer of the SBT is legitimate.

10. The system according to claim 5, wherein
the at least one processor is further configured to execute the set of instructions to:
issue the purchase certificate of an electronic book as an SBT (SoulBound Token) to the user who has purchased the electronic book; and
issue, to the user, the NFT of an NFT electronic book having same content as the electronic book purchased by the user in a case where an issuer of the SBT is legitimate.

11. The system according to claim 6, wherein
the at least one processor is further configured to execute the set of instructions to issue the NFT of the NFT electronic book such that, in a case where the NFT electronic book is resold, a larger consideration than a consideration acquired by a publisher through a sale of the electronic book is paid to the publisher.

12. A server apparatus, comprising:
at least one memory storing a set of instructions; and
at least one processor configured to execute the set of instructions to:
receive, from a store server operated by an electronic book store where a user has purchased an electronic book, an electronic book purchase notification including a wallet address of the user; and
issue, to the user, a purchase certificate that proves that the user has purchased the electronic book by using the wallet address of the user.

13. A control method of a server apparatus, the control method comprising:
receiving, from a store server operated by an electronic book store where a user has purchased an electronic book, an electronic book purchase notification including a wallet address of the user; and
issuing, to the user, a purchase certificate that proves that the user has purchased the electronic book by using the wallet address of the user.
